(19) United States
(12) Patent Application Publication
(10) Pub. No.: US 2025/0219275 A1
(43) Pub. Date: Jul. 3, 2025

(54) FILTER FOR COMMUNICATION DEVICE

(71) Applicant: KMW INC., Hwaseong-si (KR)

(72) Inventors: Joung Hoe KIM, Hwaseong-si (KR); Sang Yoong KIM, Hwaseong-si (KR)

(73) Assignee: KMW INC., Hwaseong-si (KR)

(21) Appl. No.: 19/079,527

(22) Filed: Mar. 14, 2025

Related U.S. Application Data
(63) Continuation of application No. PCT/KR2023/013772, filed on Sep. 14, 2023.

(30) Foreign Application Priority Data
Sep. 16, 2022 (KR) 10-2022-0116996
Sep. 13, 2023 (KR) 10-2023-0121564

(51) Int. Cl. H01P 1/207

(52) U.S. Cl. CPC H01P 1/207

(57) ABSTRACT

The present invention relates to a filter for a communication device, and in particular, to a filter comprising: a filter body including a cavity that is a dielectric filling space and has an open bottom; a lower cover panel made of a first material and coupled to shield the open bottom of the filter body; and a resonator frame made of a second material, wherein the lower end of the resonator frame is coupled by being forcibly fit into a plurality of fitting through-holes that are formed in the lower cover panel so as to pass through the inside and outside of the cavity and provided, spaced apart in the longitudinal direction, in two or more rows in the width direction, and then the surroundings of the plurality of fitting through-holes are fixed inside the cavity through solder bonding, thus providing the advantage of minimizing insertion loss within the cavity.

### TECHNICAL FIELD

The present disclosure relates to a filter for a communication device, and more particularly, to a filter for a communication device, which can minimize an insertion loss within a cavity because after a filter body that forms the cavity is manufactured by a deep drawing press process, a resonator frame of a heterogeneous material is coupled by being forcibly fit into a lower cover panel of a homogeneous material, which shields an opened one side of the cavity, and is then soldered and coupled therewith.

### BACKGROUND ART

In general, a wireless frequency device (also including a “communication device”), such as a radio frequency filter, has a structure in which multiple resonators are connected. Such a resonator is a circuit element that resonates in a specific frequency by a combination of an inductor L and a capacitor C in an equivalent electronic-circuit way. Each resonator has a structure in which a dielectric resonance (DR) element or a metal resonance element is installed within a metallic cylinder or a cavity, such as a rectangular parallelepiped, which is surrounded by a conductor. Accordingly, each resonator has a structure that enables the resonance of a high frequency because only an electromagnetic field having a unique frequency according to a processing frequency band within a corresponding cavity is present. In general, each resonator has a multi-stage structure in which multiple resonant stages are formed by using multiple cavities and the multiple resonant stages are sequentially connected.

An example relating to a radio frequency filter having multiple cavity structures may include an example disclosed in Korean Patent Application Publication No. 10-2004-0100084 (entitled “RADIO FREQUENCY FILTER”, laid open on Dec. 2, 2004) that was early applied by the applicant of the present disclosure.

However, the conventional radio frequency filter is provided so that each resonator extends in a thickness direction thereof within a cavity, a part of a filter tuning cover that covers the cavity is modified by using an engraving method in order to achieve a desired bandpass characteristic, and a frequency is tuned by adjusting a distance between the resonators. The conventional radio frequency filter faces significant limitations when it comes to reducing the thickness direction of the completed filter.

Furthermore, the conventional radio frequency filter requires the installation of an additional component of a conductor material in order to implement inductive coupling or capacitive coupling so as to enhance a skirt characteristic between adjacent resonators or spaced resonators within multiple cavities. There is a problem in that the weight of a completed filter is greatly increased.

Meanwhile, recently, in an antenna device to which a massive multiple input multiple output (MIMO) technology has been applied, for the slimness manufacturing of the entire product, research is in progress in order to minimize the thickness of an internal component, such as a filter. To this end, the type of filter that is most frequently used may include a dielectric ceramic filter.

However, the dielectric ceramic filter has problems in that productivity is low in that a method of manufacturing a filter body is limited to a molding method in view of its material and the variability of a subsequent frequency tuning design is low in that a shape of a cavity needs to be previously manufactured substantially according to a final frequency design value.

Meanwhile, if the material of the filter is adopted as a panel of a copper material, there is an advantage in that the reduction of the productivity can be prevented because various manufacturing methods, such as press molding, are applied. However, when the materials of resonators, which are resonant elements provided inside the filter body and its cavity, differ, a welding method is applied during the assembly process, which leads to significant insertion loss as a major issue.

### DISCLOSURE

### Technical Problem

The present disclosure has been contrived to solve the technical problems, and an object of the present disclosure is to provide a filter for a communication device, which can minimize an insertion loss within a cavity because after a filter body that forms the cavity is manufactured by a deep drawing press process, a resonator frame of a heterogeneous material is coupled by being forcibly fit into a lower cover panel of a homogeneous material, which shields an opened one side of the cavity, and is then soldered and coupled therewith.

### Technical Solution

A filter for a communication device according to an embodiment of the present disclosure includes a filter body comprising a cavity that is a dielectric filling space, the cavity having a bottom opened, a lower cover panel of a first material, which is coupled to shield the opened bottom of the filter body, and a resonator frame of a second material, which is coupled to the lower cover panel and comprises a plurality of resonant bars extending in a predetermined length toward a top surface of the filter body. The resonator frame is formed in the lower cover panel in a way to penetrate an inside and outside of the cavity, and after a bottom of the resonator frame is coupled by being forcibly fit into a plurality of fitting through holes that is spaced apart from each other in a length direction thereof and provided in two columns or more in a width direction thereof, the surroundings of the plurality of fitting through holes are fixed within the cavity through soldering and coupling.

In this case, the resonator frame may be provided to correspond to a number of columns of the plurality of fitting through holes formed in the lower cover panel. The plurality of resonant bars may be disposed to be spaced apart from each other at a predetermined distance in a length direction of the filter body so that the plurality of resonant bars does not overlap each other in a width direction of the filter body.

Furthermore, the resonator frame may include a notch forming part in which notch bars that orthogonally extend at a predetermined distance in a direction in which the notch bars are disposed from sides of the resonant bar on both sides thereof with any one of the plurality of resonant bars sequentially arranged in the length direction of the filter body interposed therebetween have been formed.

Furthermore, the notch forming part may include a C-notch part in which the notch bars are not connected and an L-notch part in which the notch bars are connected. The notch bar of the C-notch part may be formed at a location that is relatively more close to a top surface of the filter body, among the plurality of resonant bars, than the notch bar of the L-notch part.

Furthermore, the filter body and the lower cover panel may be an identical material. The first material may be a copper material. The second material may be a conductive material other than the copper material.

Furthermore, a plurality of tuning engraving surfaces that is provided at locations corresponding to locations right upward from the plurality of resonant bars, respectively, and that each adjusts a fine frequency by adjusting a separation distance from each of the plurality of resonant bars by an engraving method may be provided in the top surface of the filter body.

Furthermore, the plurality of tuning engraving surfaces may each be formed to have a smaller thickness than the top surface of the filter body. Both ends of the tuning engraving surface in a length direction thereof are integrally connected to the top surface of the filter body. Both ends of the tuning engraving surface in a width direction thereof are incised and formed with respect to the top surface of the filter body.

Furthermore, the top surface of the filter body may include a plurality of coupling adjustment surfaces that is each provided at a corresponding location between adjacent resonant bars, among the plurality of resonant bars, and that each changes a coupling value between the adjacent resonant bars by an operation of having a shape thereof deformed to protrude into the cavity by an engraving method.

Furthermore, the plurality of coupling adjustment surfaces may each be formed to have a smaller thickness than the top surface of the filter body, but any one of both ends of the coupling adjustment surface in a length direction thereof and both ends of the coupling adjustment surface in a width direction thereof may be incised and formed with respect to the top surface of the filter body.

Furthermore, the filter body may be manufactured by a deep drawing press method so that a bonding part brought into surface-contact with an end of an edge of the lower cover panel is formed.

Furthermore, the resonator frame may include a plurality of resonant bars that is parallel in a length direction thereof in two columns in a width direction of the cavity and that is spaced apart from each other at a predetermined distance, a resonator connection bar in which resonator coupling ends inserted into the plurality of fitting through holes of the lower cover panel, respectively, have been formed, and resonant characteristic ends formed at front ends of the plurality of resonant bars. The bottoms of the resonator coupling ends, which are exposed to an outside through the plurality of fitting through holes of the lower cover panel, may be soldered and coupled outside the lower cover panel.

### Advantageous Effects

The filter for a communication device according to an embodiment of the present disclosure has an effect in that the reliability of a communication device can be improved because the filter body and the resonator frame, that is, a structure within a cavity, having a heterogeneous material, are combined with a minimum amount of an insertion loss.

### DESCRIPTION OF DRAWINGS

FIG. 1 is a downward perspective view of a filter for a communication device according to an embodiment of the present disclosure.

FIG. 2 is an upper perspective view of FIG. 1.

FIG. 3 is an exploded perspective view of FIG. 1.

FIG. 4 is an exploded perspective view of FIG. 2.

FIG. 5 is an incision perspective view in which some of the components of FIG. 1 are incised so that a cavity appears.

FIG. 6 is a vertical cross-sectional view taken along line A-A in FIG. 1 and a partially enlarged view illustrating a form in which a mounting panel of a filter body and a lower cover panel, among the components thereof, are combined and a form in which the lower cover panel and a resonator frame are combined.

FIG. 7 is a horizontal cross-sectional view taken along line B-B in FIG. 1.

FIG. 8 is a vertical cross-sectional view taken along line A-A in FIG. 1 and a partially enlarged view illustrating a coupling adjustment bar among the components thereof.

FIG. 9 is a vertical cross-sectional view taken along line A-A in FIG. 1 and a partially enlarged view illustrating a tuning engraving surface, among the components thereof.

FIG. 10 is a plan view (a) of FIG. 1, a plan view (b) of the resonator frame, and an internal perspective plan view (c).

### DESCRIPTION OF REFERENCE NUMERALS

100: filter for communication device 105: filter body
110: mounting edge panel 120: one-side thickness forming panel
130: other-side thickness forming panel 150: body top-forming panel
180A: one-side shield panel 180B: other-side shield panel
200: resonator frame 210: resonator connection bar
215: resonator coupling ends 220: resonant bars
230: resonant characteristic ends 300: lower cover panel
310h: fitting through hole

### BEST MODE

Hereinafter, a filter for a communication device according to an embodiment of the present disclosure is described in detail with reference to the accompanying drawings.

In adding reference numerals to the components of each drawing, it should be noted that the same components have the same reference numerals as much as possible even if they are displayed in different drawings. Furthermore, in describing embodiments of the present disclosure, when it is determined that a detailed description of the related well-known configuration or function hinders understanding of an embodiment of the present disclosure, the detailed description thereof will be omitted.

In describing components of an embodiment of the present disclosure, terms, such as a first, a second, A, B, (a), and (b), may be used. Such terms are used only to distinguish one component from another component, and the essence, order, or sequence of a corresponding component is not limited by the terms. All terms used herein, including technical or scientific terms, have the same meanings as those commonly understood by a person having ordinary knowledge in the art to which the present disclosure pertains, unless defined otherwise in the specification. Terms, such as those commonly used and defined in dictionaries, should be construed as having the same meanings as those in the context of a related technology, and are not construed as having ideal or excessively formal meanings unless explicitly defined otherwise in the specification.

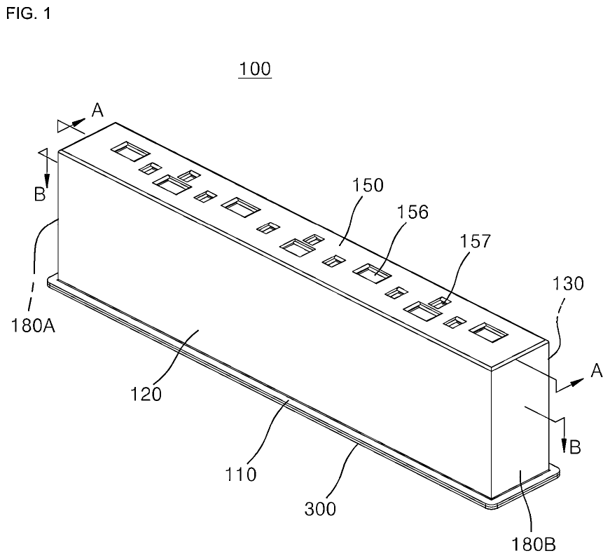

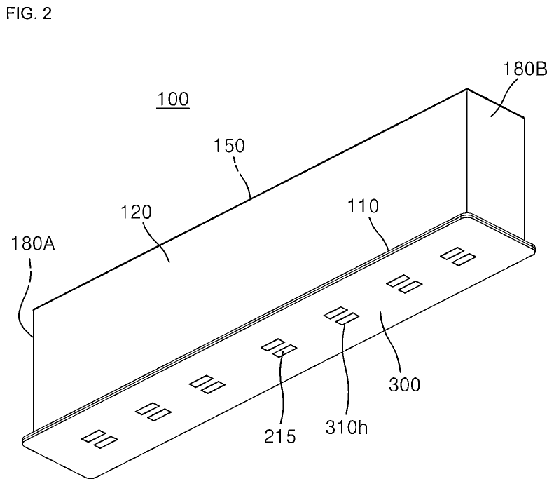

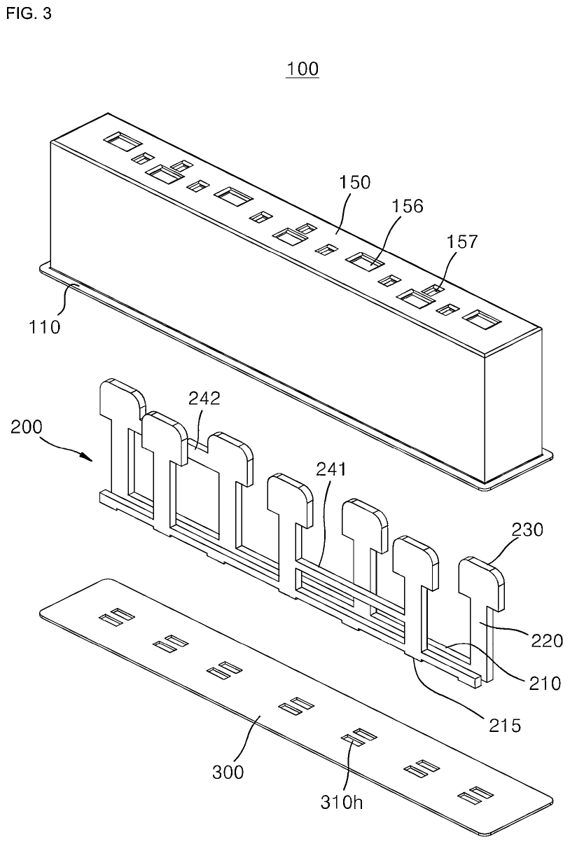

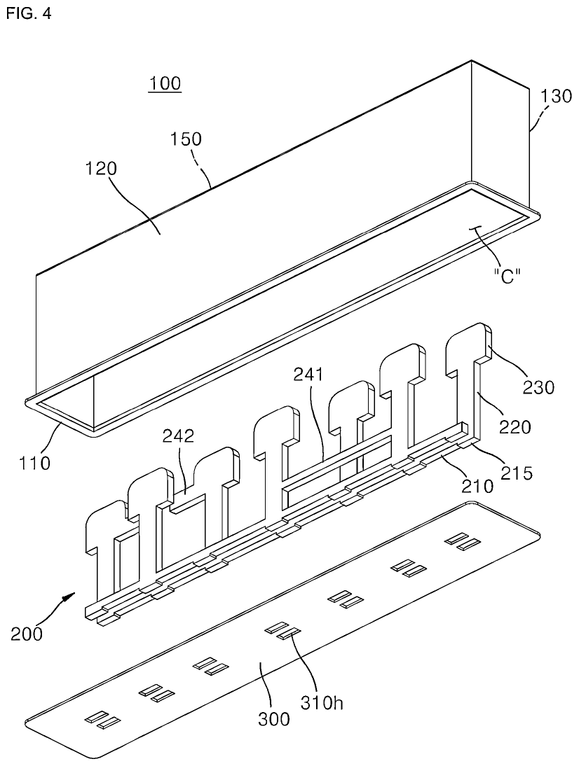

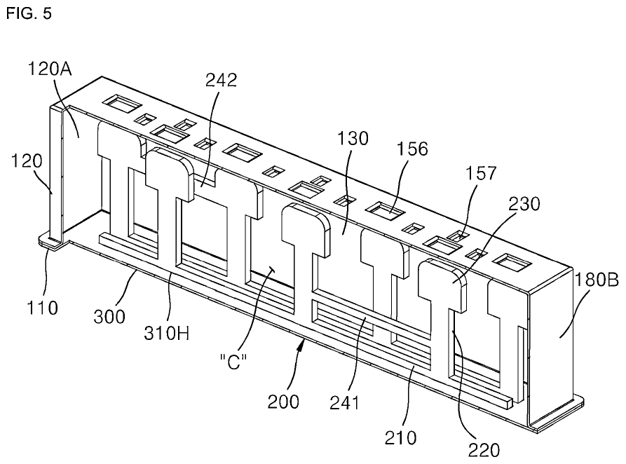

FIG. 1 is a downward perspective view of a filter for a communication device according to an embodiment of the present disclosure. FIG. 2 is an upper perspective view of FIG. 1. FIG. 3 is an exploded perspective view of FIG. 1. FIG. 4 is an exploded perspective view of FIG. 2. FIG. 5 is an incision perspective view in which some of the components of FIG. 1 are incised so that a cavity appears.

As referred to in FIGS. 1 to 5, the filter for a communication device according to an embodiment of the present disclosure includes a cavity C that is a dielectric filling space, a filter body 105 including an opened bottom of the cavity C, a lower cover panel 300 coupled to shield the opened bottom of the cavity C of the filter body 105, and a resonator frame 200 coupled to the lower cover panel 300 and including a plurality of resonant bars 220 that extends in a predetermined length toward an upper surface thereof within the cavity C of the filter body 105.

In this case, the filter body 105 and the lower cover panel 300 that substantially form the internal surface of the cavity C may each be formed of a metal panel member having a first material, that is, the same material. Furthermore, the first material adopted as the metal panel members of the filter body 105 and the lower cover panel 300 may be a copper material having excellent conductivity.

As referred to in FIGS. 1 to 5, the filter body 105 may include a mounting edge panel 110 that is orthogonally curved at the end of an edge of the opened bottom of the cavity C of the filter body 105 and extends to the outside, one-side thickness forming panel 120 and other-side thickness forming panel 130 that extend in the thickness direction of the cavity C as one-side end and other-side end of the cavity C in a width direction thereof, a body top-forming panel 150 that forms the upper part of the cavity C, and one-side shield panel 180A and other-side shield panel 180B that shield one-side and the other-side opened portions of the cavity C in a length direction thereof.

Hereinafter, terms related to a “direction” and a “location” described in the detailed description of the present disclosure may be defined as follows so that the filter 100 for a communication device according to an embodiment of the present disclosure can be understood more clearly.

That is, the “length direction” is a direction that penetrates both ends that are formed relatively longer than a width or a thickness and may be defined as a direction that is orthogonally directed toward the one-side shield panel 180A and the other-side shield panel 180B. The “width direction” may be defined as a direction that is orthogonally directed toward the one-side thickness forming panel 120 and the other-side thickness forming panel 130. The “thickness direction” may be defined as a direction that is orthogonally directed toward the body top-forming panel 150 and the lower cover panel 300.

Meanwhile, the lower cover panel 300 is formed to have a size corresponding to the end of an edge of the mounting edge panel 110, among the components of the filter body 105, and the end of an edge of the lower cover panel 300 may be coupled to the end of the edge of the mounting edge panel 110 in a surface bonding way.

More specifically, a bottom of the mounting edge panel 110 that forms the end of an edge of the filter body 105 may be coupled to an upper surface of the end of the edge of the lower cover panel 300 in a surface bonding way.

In this case, the surface bonding method of the mounting edge panel 110 of the filter body 105 and the end of the edge of the lower cover panel 300 may be performed by a welding method, and may be preferably soldered and combined in an SMT way.

In this case, assuming that the filter body 105 and the lower cover panel 300 are manufactured by a press method through a plate mold, the cavity C may be formed lengthily in a left and right length direction, and may be formed to have a rectangular parallelepiped shape in which the front and rear width of the cavity is smaller than a size of an up and lower height.

When the plurality of filter bodies 105 each having the cavity C having such a shape is disposed with respect to an antenna housing body (not illustrated) having a closure shape having a front opened, if the body top-forming panel 150 is disposed to form a front surface of the cavity and the one-side thickness forming panel 120 and the other-side thickness forming panel 130 are disposed to form left and right sides of the cavity, there is an advantage in that the filter bodies 105 of many columns can be installed in the installation space of the antenna housing body in left and right directions thereof.

Furthermore, if the body top-forming panel 150 and the lower cover panel 300 are disposed to form the left and right sides and the one-side shield panel 180A and the other-side shield panel 180B are disposed to form top and bottom surfaces with respect to the installation space of the antenna housing body, there is an advantage in that the plurality of filter bodies 105 can be slimly installed forth and back even without greatly occupying a space of the installation space of the antenna housing body in front and rear directions thereof.

Meanwhile, as referred to in FIGS. 3 and 4, the resonator frame 200 may be formed in the lower cover panel 300 in a way to penetrate the inside and outside of the cavity C, and may have bottoms coupled by being forcibly fit into a plurality of fitting through holes 310h of two columns or more in a width direction thereof, which are spaced apart from each other in a length direction thereof. Thereafter, the surroundings of the plurality of fitting through holes 310h may be soldered and coupled within the cavity C. In this case, the bottom of the resonator frame 200 refers to a portion that the lower cover panel 300 neighbors, among both ends of the resonator frame in a thickness direction thereof.

Furthermore, as described above, the one-side thickness forming panel 120, the other-side thickness forming panel 130, the one-side shield panel 180A, the other-side shield panel 180B, and the body top-forming panel 150 may be integrally formed with the filter body 105 by using a thin metal sheet having a thickness of 3.0 t or less, which is provided as a copper material as the first material, through a deep drawing press method. Furthermore, the mounting edge panel 110 may also be integrally formed with the filter body by a single press method.

Furthermore, the lower cover panel 300 is provided as a copper material as the same first material as that of the filter body 105, and may be manufactured by a press method (metal sheet) not the deep drawing press method.

Meanwhile, a plurality of resonant bars 220 may be integrally formed in the resonator frame 200 by using a sheet material having a predetermined thickness or more (a size that is greater than at least 3.0 t, that is, the thickness of the filter body 105), which is provided as a SUS material as a second material, that is, a material different from that of the filter body 105 and the lower cover panel 300 each provided as a copper material, that is, the first material, through a press process (metal sheet).

In this case, the lower cover panel 300 with which the resonator frame 200 is coupled is the first material adopted as a copper material, and the resonator frame 200 is provided as the second material adopted as the SUS material different from the first material. If the resonator frame 200 stands upright directly on the inner surface of the lower cover panel 300 and is combined with the lower cover panel along a contact end therebetween through a welding coupling method, there are problems in that a coupling force therebetween is weak and the welding coupling method increases an insertion loss within the cavity C.

Accordingly, in the filter 100 for a communication device according to an embodiment of the present disclosure, in order to minimize the insertion loss and also for stable internal coupling, as described above, the surroundings of the bottom of the resonator frame 200 that protrude to the outside through the plurality of fitting through holes 310h are soldered and coupled.

Meanwhile, as referred to in FIGS. 3 and 4, the resonator frame 200 may include the plurality of resonant bars 220 that are provided to be parallel to each other in a length direction thereof in two columns in the width direction of the cavity C and to be spaced apart from each other at a predetermined distance, a resonator connection bar 210 that connects the bottoms of the resonant bars 220 of each column and in which resonator coupling ends 215 inserted into the plurality of fitting through holes 310h, respectively, and having bottoms exposed to the outside of the cavity C have been formed, and resonant characteristic ends 230 formed at the front ends (tops) of the respective resonant bars 220.

In this case, the plurality of resonant bars 220 is provided to be arranged by being spaced apart from each other in each length direction thereof within the cavity C. The resonant bars 220 that are adjacent to each other may be arranged to be spaced apart from each other in zigzags so that the resonant bars are adjacently coupled between a first column and a second column in a width direction thereof.

That is, the resonator frame 200 is provided to correspond to the number of columns of the plurality of fitting through holes 310h formed in the lower cover panel 300. The plurality of resonant bars 220 may be disposed to be spaced apart from each other at a predetermined distance in the length direction of the filter body 105 so that the plurality of resonant bars does not overlap each other in a width direction of the filter body 105.

Meanwhile, the resonator frame 200 may include notch forming parts 241 and 242 in which notch bars that orthogonally extend at a predetermined distance in a direction in which the notch bars are disposed from the sides of the resonant bar 220 on both sides thereof with any one of the plurality of resonant bars 220 sequentially arranged in the length direction of the filter body 105 interposed therebetween have been formed.

In this case, the notch forming parts 241 and 242 include an L-notch part 241 formed so that a pair of resonant bars 220 spaced apart from each other in a way that the notch bar skips at least one or more adjacent resonant bars 220 is connected and an C-notch part formed so that a pair of resonant bars 220 spaced apart from each other in a way that the notch bar skips at least one or more adjacent resonant bars 220 is not connected. The notch bar of the C-notch part 242 may be formed at a location (e.g., the resonant characteristic end 230) relatively closer to a top surface of the filter body 105, among the plurality of resonant bars 220, than the notch bar of the L-notch part 241.

Meanwhile, the filter body 105 and the lower cover panel 300 may be the same material, the first material may be a copper material, and the second material that forms the resonant bars 220 of the resonator frame 200 may be a conductive material (preferably, an SUS material) other than the copper material as already described above.

Furthermore, a plurality of tuning engraving surfaces 156 that is provided at locations corresponding to locations right upward from the plurality of resonant bars 220, respectively, but each adjusts a fine frequency by adjusting a separation distance from each of the plurality of resonant bars 220 by an engraving method may be provided in the top surface of the filter body 105.

If the plurality of tuning engraving surfaces 156 is each formed to have a smaller thickness than the top surface of the filter body 105, but the plurality of tuning engraving surfaces 156 is each lengthily formed to have a rectangle in a length direction thereof, for example, both ends of the tuning engraving surface in the length direction may be integrally connected to the body top-forming panel 150 corresponding to the top surface of the filter body 105, and both ends of the tuning engraving surface in a width direction thereof may be incised and formed with respect to the body top-forming panel 150 corresponding to the top surface of the filter body 105.

Furthermore, the top surface of the filter body 105 may include a plurality of coupling adjustment surfaces 157 that is each provided at a corresponding location between adjacent resonant bars 220, among the plurality of resonant bars 220, and that each changes a coupling value between the adjacent resonant bars 220 by an operation of having a shape thereof deformed to protrude into the cavity C by an engraving method.

In this case, if the plurality of coupling adjustment surfaces 157 is each formed to have a smaller thickness than the top surface of the filter body 105, but the plurality of coupling adjustment surfaces 157 is each lengthily formed to have a rectangle in a width direction thereof, any one of both ends of the coupling adjustment surface in a length direction thereof on the basis of a shape thereof and both ends of the coupling adjustment surface in the width direction may be incised and formed with respect to the body top-forming panel 150 corresponding to the top surface of the filter body 105. Accordingly, the front end of each of the plurality of coupling adjustment surfaces 157 on a side opposite to a portion of the filter body 105, which is not incised with respect to the body top-forming panel 150, is supported in a cantilever form, and thus has a shape deformed between the plurality of resonant bars 220 by an external force that is transferred from the outside.

The filter 100 for a communication device having such components according to an embodiment of the present disclosure has an advantage of greatly improving communication reliability of a communication device because the filter includes the lower cover panel 300 that forms the filter body 105 by the deep drawing press method and that shields the opened bottom of the filter body 105, but the resonator frame 200, that is, a heterogeneous material, is coupled in a way to be stable and so that the amount of an insertion loss is minimized through the forcibly fitting coupling method and soldering and coupling.

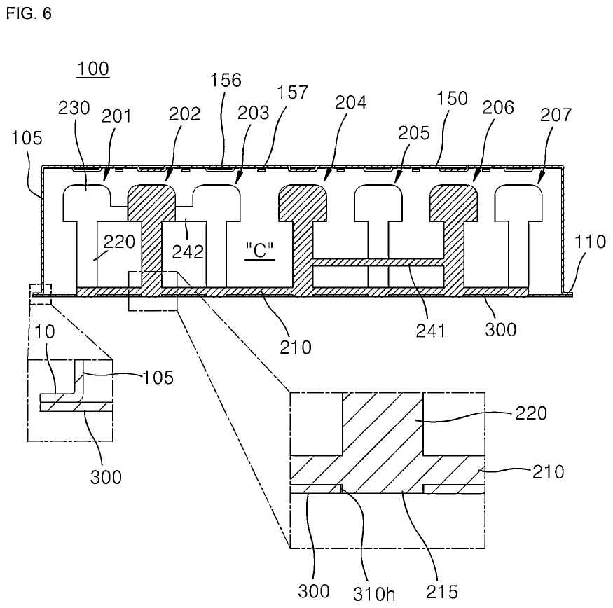

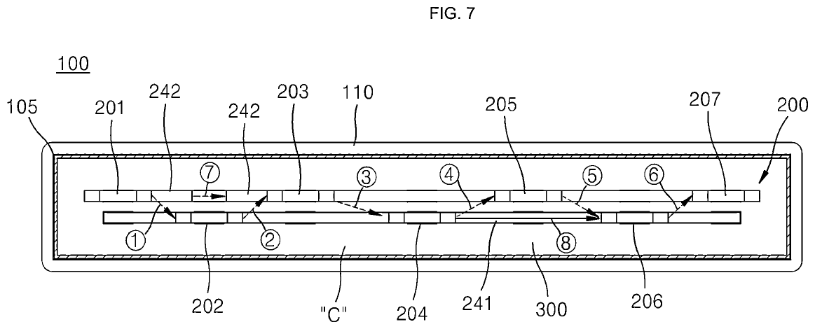

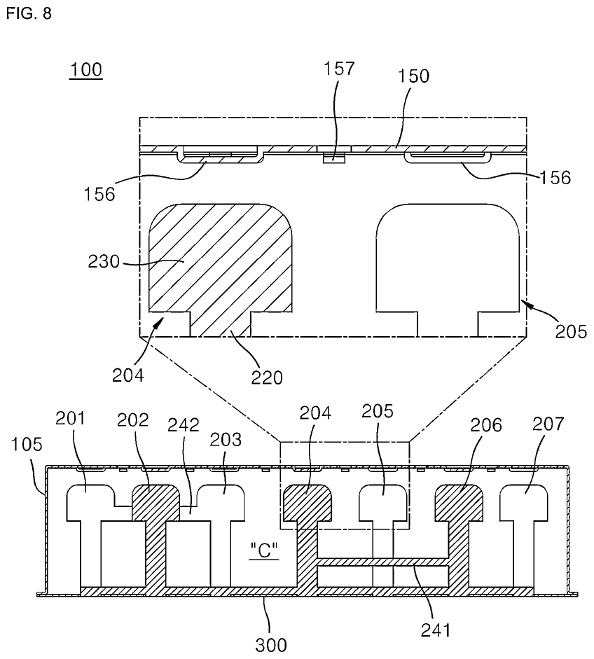

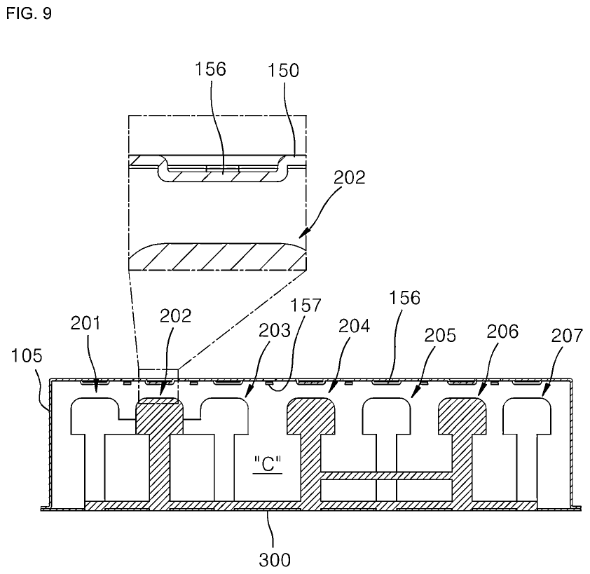

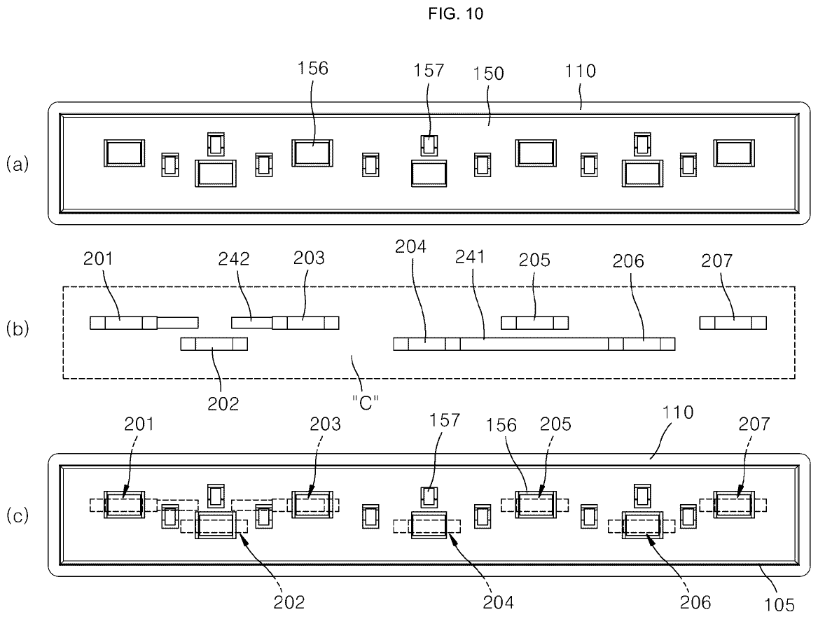

FIG. 6 is a vertical cross-sectional view taken along line A-A in FIG. 1 and a partially enlarged view illustrating a form in which a mounting panel of a filter body and a lower cover panel, among the components thereof, are combined and a form in which the lower cover panel and a resonator frame are combined. FIG. 7 is a horizontal cross-sectional view taken along line B-B in FIG. 1. FIG. 8 is a vertical cross-sectional view taken along line A-A in FIG. 1 and a partially enlarged view illustrating a coupling adjustment bar among the components thereof. FIG. 9 is a vertical cross-sectional view taken along line A-A in FIG. 1 and a partially enlarged view illustrating a tuning engraving surface, among the components thereof. FIG. 10 is a plan view (a) of FIG. 1, a plan view (b) of the resonator frame, and an internal perspective plan view (c).

Acting effects in view of the productivity and frequency tuning design of the filter 100 for a communication device according to an embodiment of the present disclosure, which has been described with reference to FIGS. 1 to 5, are described briefly as follows with reference to FIGS. 6 to 10.

First, as referred to in FIG. 6, the filter 100 for a communication device according to an embodiment of the present disclosure can greatly improve the productivity of a product by breaking from a molding method using a conventional molding material because the filter body 105 is formed simultaneously with the body top-forming panel 150, the one-side thickness forming panel 120 and the other-side thickness forming panel 130, the one-side shield panel 180A and the other-side shield panel 180B, and the mounting edge panel 110 through the deep drawing press method, that is, one of press methods.

The application of the deep drawing press method as a method of manufacturing the filter body 105 provides an advantage in that an insertion loss according to the installation of a separate structure conventionally can be previously blocked in that components within the cavity C can be simplified other than the separate coupling of the lower cover panel 300 and the resonator frame 200.

Furthermore, as referred to in FIG. 6, the lower cover panel 300 that shields the opened bottom of the cavity C of the filter body 105 may be formed to have an appearance corresponding to an outside edge of the mounting edge panel 110 of the filter body 105 through the press method. Furthermore, the plurality of fitting through holes 310h for the soldering and coupling of the resonator frame 200 may be formed through a single press process.

The filter body 105 and the lower cover panel 300 that are manufactured through the deep drawing press method and the press method as described above have the bottom of the mounting edge panel 110 and the top of the end of the edge of the lower cover panel 300 to be mutually surface-bonded with each other as referred to in FIG. 6, but may be soldered and coupled in an SMT way after a solder material is interposed therebetween. Accordingly, there is an advantage in that an insertion loss within the cavity C is greatly reduced.

Furthermore, in installing the resonator frame 200 within the cavity C, as referred to in FIG. 6, each of the resonator coupling ends 215 of the resonator frame 200 may be fit, inserted, and coupled so that the bottom of each of the resonator coupling ends is exposed to the outside through each of the plurality of fitting through holes 310h formed in the lower cover panel 300, and may be then fixed through soldering and coupling on the outside. Accordingly, there is an advantage in that an insertion loss attributable to a conventional welding coupling process can be fully blocked by fully deleting the welding coupling process within the cavity C.

Acting effects in view of the frequency tuning design of the filter 100 for a communication device according to an embodiment of the present disclosure are described below.

As referred to in FIG. 7, the plurality of resonant bars 220 of the resonator frame 200 includes seven resonant bars 201 to 207 that are disposed to be spaced apart from each other within the cavity C from one side to the other side thereof in a length direction thereof, and is disposed to perform a process of filtering signals input through the first resonant bar 201 on one side sequentially via the second resonant bar 202 to the sixth resonant bars 206 and then output the signals through the seventh resonant bar 207 on the other side.

In this case, in general, signal paths between resonant bars (e.g., between the first resonant bar 201 and the second resonant bar 202, between the second resonant bar 202 and the third resonant bar 203, between the third resonant bar 203 and the fourth resonant bar 204, between the fourth resonant bar 204 and the fifth resonant bar 205, between the fifth resonant bar 205 and the sixth resonant bar 206, and between the sixth resonant bar 206 and the seventh resonant bar 207) that are adjacent to each other from the first resonant bar 201 to the seventh resonant bar 207 are defined as reference numerals “\textcircled{1} to \textcircled{6}”. Filtering is sequentially performed on resonant bars 220 adjacent to each other, among the resonant bars 220, in order of the signal paths “\textcircled{1} to \textcircled{6}”.

In this case, a signal path \textcircled{7} for implementing a C-notch at the left end (a low frequency region) of a passband may be further formed through capacitive coupling by the C-notch part 242 formed in each of the first resonant bar 201 and the second resonant bar 202. A signal path \textcircled{8} for implementing an L-notch at the right end (a high frequency region) of the passband may be further formed through inductive coupling by the L-notch part 241 formed to connect the fourth resonant bar 204 and the sixth resonant bar 206.

Meanwhile, referring to FIGS. 8 and 9, the plurality of tuning engraving surfaces 156 may be formed in the body top-forming panel 150 corresponding to the locations of the resonant characteristic ends 230 of the resonant bars 201 to 207 of the resonator frame 200, respectively. The plurality of coupling adjustment surfaces 157 may be formed in the body top-forming panel 150 corresponding to a space between the resonant bars 201.

The filter 100 for a communication device having such components according to an embodiment of the present disclosure can perform adjacent coupling and cross-coupling along the signal paths \textcircled{1} to \textcircled{6} and perform coupling for forming the L-notch and the C-notch along the additional signal paths \textcircled{7} and \textcircled{8} in a process of signal being output through the seventh resonant bar 207 when the signal is input through the first resonant bar 201 adjacent to one side of the cavity C as referred to in FIG. 10.

The filter for a communication device according to an embodiment of the present disclosure has been described above in detail with reference to the accompanying drawings. However, an embodiment of the present disclosure is not essentially limited to the aforementioned embodiment, and may include various modifications and implementations within an equivalent range thereof by a person having ordinary knowledge in the art to which the present disclosure pertains. Accordingly, the true range of a right of the present disclosure will be said to be defined by the appended claims

### INDUSTRIAL APPLICABILITY

The present disclosure provides the filter for a communication device, which can minimize an insertion loss within a cavity because after the filter body that forms the cavity is manufactured by the deep drawing press process, the resonator frame of a heterogeneous material is coupled by being forcibly fit into the lower cover panel of a homogeneous material, which shields the opened one side of the cavity, and is then soldered and coupled therewith.

1. A filter for a communication device comprising:
a filter body comprising a cavity that is a dielectric filling space, the cavity having a bottom opened;
a lower cover panel of a first material, which is coupled to shield the opened bottom of the filter body; and
a resonator frame of a second material, which is coupled to the lower cover panel and comprises a plurality of resonant bars extending in a predetermined length toward a top surface of the filter body,
wherein the resonator frame is formed in the lower cover panel in a way to penetrate an inside and outside of the cavity, and after a bottom of the resonator frame is coupled by being forcibly fit into a plurality of fitting through holes that is spaced apart from each other in a length direction thereof and provided in two columns or more in a width direction thereof, surroundings of the plurality of fitting through holes are fixed within the cavity through soldering and coupling.

2. The filter of claim 1, wherein:
the resonator frame is provided to correspond to a number of columns of the plurality of fitting through holes formed in the lower cover panel,
the plurality of resonant bars is disposed to be spaced apart from each other at a predetermined distance in a length direction of the filter body so that the plurality of resonant bars does not overlap each other in a width direction of the filter body.

3. The filter of claim 2, wherein the resonator frame comprises a notch forming part in which notch bars that orthogonally extend at a predetermined distance in a direction in which the notch bars are disposed from sides of the resonant bar on both sides thereof with any one of the plurality of resonant bars sequentially arranged in a length direction of the filter body interposed therebetween have been formed.

4. The filter of claim 3, wherein:
the notch forming part comprises a C-notch part in which the notch bars are not connected and an L-notch part in which the notch bars are connected, and
the notch bar of the C-notch part is formed at a location that is relatively more close to a top surface of the filter body, among the plurality of resonant bars, than the notch bar of the L-notch part.

5. The filter of claim 1, wherein:
the filter body and the lower cover panel are an identical material,
the first material is a copper material, and
the second material is a conductive material other than the copper material.

6. The filter of claim 1, wherein a plurality of tuning engraving surfaces that is provided at locations corresponding to locations right upward from the plurality of resonant bars, respectively, and that each adjusts a fine frequency by adjusting a separation distance from each of the plurality of resonant bars by an engraving method is provided in the top surface of the filter body.

7. The filter of claim 6, wherein:
the plurality of tuning engraving surfaces is each formed to have a smaller thickness than the top surface of the filter body,
both ends of the tuning engraving surface in a length direction thereof are integrally connected to the top surface of the filter body, and
both ends of the tuning engraving surface in a width direction thereof are incised and formed with respect to the top surface of the filter body.

8. The filter of claim 5, wherein the top surface of the filter body comprises a plurality of coupling adjustment surfaces that is each provided at a corresponding location between adjacent resonant bars, among the plurality of resonant bars, and that each changes a coupling value between the adjacent resonant bars by an operation of having a shape thereof deformed to protrude into the cavity by an engraving method.

9. The filter of claim 8, wherein the plurality of coupling adjustment surfaces is each formed to have a smaller thickness than the top surface of the filter body, but any one of both ends of the coupling adjustment surface in a length direction thereof and both ends of the coupling adjustment surface in a width direction thereof is incised and formed with respect to the top surface of the filter body.

10. The filter of claim 1, wherein the filter body is manufactured by a deep drawing press method so that a bonding part brought into surface-contact with an end of an edge of the lower cover panel is formed.

11. The filter of claim 1, wherein the resonator frame comprises:
a plurality of resonant bars that is parallel in a length direction thereof in two columns in a width direction of the cavity and that is spaced apart from each other at a predetermined distance;
a resonator connection bar in which resonator coupling ends inserted into the plurality of fitting through holes of the lower cover panel, respectively, have been formed; and
resonant characteristic ends formed at front ends of the plurality of resonant bars, and
wherein bottoms of the resonator coupling ends, which are exposed to an outside through the plurality of fitting through holes of the lower cover panel, are soldered and coupled outside the lower cover panel.
